(19) United States
(12) Patent Application Publication
(10) Pub. No.: US 2008/0007171 A1
(43) Pub. Date: Jan. 10, 2008

(54) Electroluminescent device

(76) Inventors: Tae-Won Jeong, Yongin-si (KR); Shang-Hyeun Park, Yongin-si (KR); Jeong-Na Heo, Yongin-si (KR); Jeong-Hee Lee, Yongin-si (KR); Jong-Min Kim, Yongin-si (KR); Jin-Pyo Hong, Yongin-si (KR); Yong-Wan Jin, Yongin-si (KR); Byong-Gwon Song, Yongin-si (KR)

Correspondence Address: Robert E. Bushnell, Suite 300, 1522 K Street, N.W., Washington, DC, 20005-1202, US

(21) Appl. No.: 11/730,720

(22) Filed: Apr. 3, 2007

(30) Foreign Application Priority Data
Jul. 5, 2006 (KR) 10-2006-0062977

(51) Int. Cl. H01J 63/04

(52) U.S. Cl. 313/506

(57) ABSTRACT

An electroluminescent device uses nano structures having a wide surface area. The electroluminescent device includes a substrate, a first electrode having a plurality of nano structures formed on an upper surface of the substrate, a dielectric layer formed so as to correspond to the shape of the nano structures, a light emitting layer formed so as to correspond to the shape of the dielectric layer, and a second electrode covering the light emitting layer. A surface of the second electrode facing the light emitting layer is separated by a predetermined distance from a surface of the nano structures.

### CLAIM OF PRIORITY

This application makes reference to, incorporates the same herein, and claims all benefits accruing under 35 U.S.C. § 119 from an application for ELECTROLUMINESCENT DEVICE earlier filed in the Korean Intellectual Property Office on the 5 Jul. 2006 and there duly assigned Serial No. 10-2006-0062977.

### BACKGROUND OF THE INVENTION

1. Technical Field

The present invention relates to an electroluminescent device, and more particularly, to an electroluminescent device that uses a nano structure having a large surface area.

2. Related Art

An electroluminescent device is an active matrix type display device that is expected to become the next generation of display device due to its wide viewing angle, high contrast, and high response speed.

In an electroluminescent device, a transparent first electrode is formed of indium tin oxide (ITO) on a first substrate. An inorganic light emitting layer that emits electric fields is formed on the transparent first electrode. A dielectric layer and a second electrode are sequentially formed on the inorganic light emitting layer. A second substrate is formed on an upper surface of the second electrode. The electroluminescent device is operated by alternating current (AC) electricity.

In the above electroluminescent device, when a predetermined voltage is applied between the transparent first electrode and the second electrode, an electric field is formed in the inorganic light emitting layer, and visible light is emitted from a phosphor material in the inorganic light emitting layer by the electric field.

The electroluminescent device is renown due to its long lifetime and low cost. However, there are limitations on the material characteristics of the electroluminescent device when developing the electroluminescent device. That is, there is a limit in developing a dielectric that can increase capacitance in order to increase the brightness of the electroluminescent device and to reduce an operating voltage of the electroluminescent device.

### SUMMARY OF THE INVENTION

The present invention provides an electroluminescent device that exhibits a low operating voltage and high brightness by increasing capacitance and enlarging a light emission area. According to an aspect of the present invention, the electroluminescent device includes a substrate, a first electrode having a plurality of nano structures formed on an upper surface of the substrate, a dielectric layer formed to correspond to the shape of the nano structures, a light emitting layer formed to correspond to the shape of the dielectric layer, and a second electrode covering the light emitting layer. A surface of the second electrode facing the light emitting layer is separated by a predetermined distance from the surface of the nano structures.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of an electroluminescent device;

FIG. 2 is a cross-sectional view of an electroluminescent device according to an embodiment of the present invention;

FIG. 3 is a cross-sectional view of a modified version of a second electrode of the electroluminescent device illustrated in FIG. 2 according to an embodiment of the present invention;

FIGS. 4A thru 4D are scanning electron microscope (SEM) images of a dielectric deposited on carbon nanotubes (CNTs);

FIG. 5 is a graph showing a capacitance ratio according to the radius of the CNTs and the thickness of a dielectric of the electroluminescent device according to an embodiment of the present invention;

FIG. 6 is a graph showing a capacitance ratio according to the length of the CNTs and the kind of dielectric of the electroluminescent device according to an embodiment of the present invention;

FIG. 7 is a graph showing a relationship between operation voltage and brightness according to the growing time of CNTs of the electroluminescent device according to an embodiment of the present invention; and

FIG. 8 is a photograph showing light emission of the electroluminescent device according to an embodiment of the present invention.

### DETAILED DESCRIPTION OF THE INVENTION

The electroluminescent device according to an embodiment of the present invention will now be described with reference to accompanying drawings in which exemplary embodiments of the invention are shown.

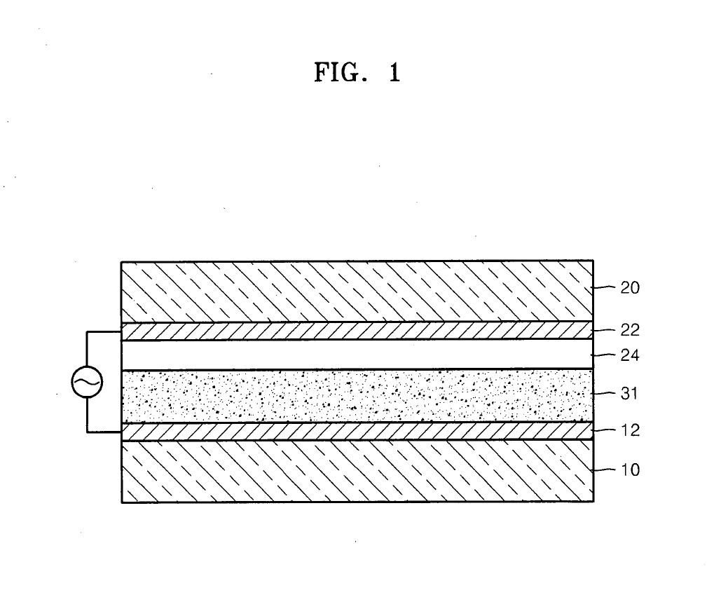

FIG. 1 is a cross-sectional view of the electroluminescent device.

Referring to FIG. 1, a transparent first electrode 12 is formed of indium tin oxide (ITO) on a first substrate 10. An inorganic light emitting layer 31 which emits electric fields is formed on the transparent first electrode 12. A dielectric layer 24 and a second electrode 22 are sequentially formed on the inorganic light emitting layer 31. A second substrate 20 is formed on an upper surface of the second electrode 22. The electroluminescent device is operated by alternating current (AC) electricity.

In the above electroluminescent device, when a predetermined voltage is applied between the transparent first electrode 12 and the second electrode 22, an electric field is formed in the inorganic light emitting layer 31, and visible light is emitted from a phosphor material in the inorganic light emitting layer 31 due to the electric field.

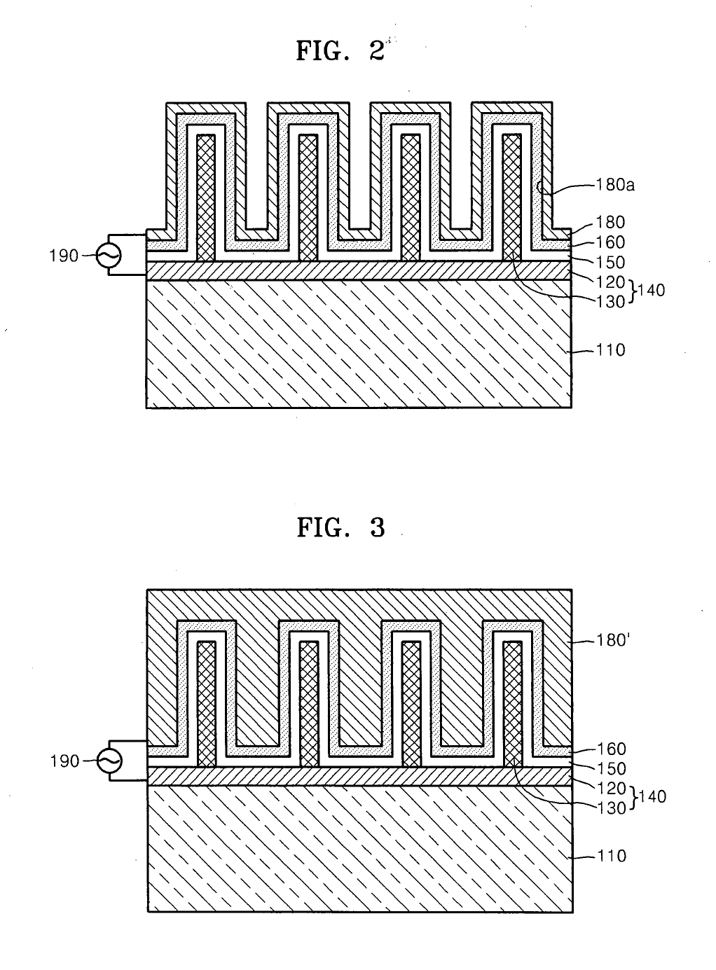

FIG. 2 is a cross-sectional of the electroluminescent device according to an embodiment of the present invention.

Referring to FIG. 2, the electroluminescent device according to an embodiment of the present invention includes a substrate 110, a first electrode 140 having an electrode pad 120 and a plurality of nano structures 130 formed on the substrate 110, a dielectric layer 150 formed along surfaces of the nano structures 130, a light emitting layer 160 formed along the surface of the dielectric layer 150, and a second electrode 180 covering the light emitting layer 160. The surface of the second electrode 180 on a side of the light emitting layer 160 is separated a predetermined distance from the first electrode 140 along the surface of the nano structures 130. A sealing member (not shown) that seals the first electrode 140, the dielectric layer 150, the light emitting layer 160, and the second electrode 180 from the outside can further be formed on the second electrode 180. For convenience of explanation, the sealing member is not included in the embodiments that will be described.

The substrate 110 can be a transparent glass substrate that contains SiO₂ as the main ingredient. Also, the substrate 110 can be a plastic substrate, for example, a flexible type of polymer substrate.

The first and second electrodes 140 and 180, respectively, are electrically connected to an external AC power source 190 so as to generate an electric field in the light emitting layer 160 formed between the first electrode 140 and the second electrode 180.

The first electrode 140 includes the electrode pad 120 and the nano structures 130.

The electrode pad 120 electrically connects the nano structures 130 to the external AC power source 190, and can be formed of a transparent material, for example, indium tin oxide (ITO). Also, the electrode pad 120 may be formed of a material on which the nano structures 130 can easily grow. The electrode pad 120 may not be formed if the substrate 110 is formed of a conductive material and a voltage is applied to the nano structures 130 via the substrate 110.

The electroluminescent device according to an embodiment of the present invention can be used as a single light emitting device, and also can be used in a flat display panel or a luminous apparatus. When the electroluminescent device according to an embodiment of the present invention is used in a flat display panel, the electrode pad 120 and the second electrode 180 are patterned in accordance with a predetermined pattern corresponding to the pixels of the flat display panel. This pattern varies according to the driving method. For example, if the flat display panel is a passive matrix (PM) type, the electrode pad 120 and the second electrode 180 can be formed to be address lines with a stripe shape and separated by a predetermined distance from each other. If the flat display panel is an active matrix (AM) type, a thin film transistor (TFT) layer having at least one TFT is further included between the electrode pad 120 and the substrate 110, and the electrode pad 120 is electrically connected to the TFT layer. The patterns of electrode according to driving methods are well known in the art, and thus the descriptions thereof will be omitted. In this way, as the electrode pad 120 and the second electrode 180 are patterned, the electroluminescent device according to an embodiment of the present invention can be used as a flat display panel in which each pixel unit is independently driven. The plurality of nano structures 130, which are a feature of the present invention, are formed on an upper surface of the electrode pad 120 in a nano size scale.

Since the nano structure 130 functions together with the electrode pad 120 as the first electrode 140, the nano structure 130 is electrically conductive. The nano structures 130 can be formed of, for example, a carbon nanotube (CNT), an SiC nano wire, a metal nano wire, or a metal oxide nano wire. The CNT is not limited to single-walled nanotubes (SWNTs) or multiwalled nanotubes (MWNTs). The metal oxide nano wire includes ZnO or TiO₂. The nano structures 130 can be grown using a method well known in the art, such as an atomic layer deposition (ALD) method or a plasma enhanced chemical vapor deposition (PECVD) method. If the nano structures 130 are grown using the PECVD method, the length of the nano structures 130 can be precisely controlled since the deposition is performed in cycles of an atomic layer unit. Also, the nano structures 130 may be grown perpendicular to an upper surface of the substrate 110 so that the dielectric layer 150, the light emitting layer 160, and the second electrode 180, which cover the nano structures 130 can be uniformly deposited, and as a result, a uniform electric field can be formed in the dielectric layer 150 and the light emitting layer 160.

The nano structures 130 are spaced apart from each other by a gap so that the dielectric layer 150 and the light emitting layer 160, which will be described later, can be deposited along the surface of the nano structures 130. The gap between the nano structures 130 can be set to be wide enough so that the dielectric layer 150 and the light emitting layer 160 can be deposited, even if the nano structures 130 are grown using a conventional method, since the dielectric layer 150 and the light emitting layer 160 are deposited to be thin. When catalyst dots are used, more uniform nano structures 130 can be formed. For example, the uniform nano structures 130 can be formed by growing multi-walled nanotubes on nickel catalyst dots (not shown) after the nickel catalyst dots are formed on the electrode pad 120 by being spaced apart by a predetermined gap.

A conventional electroluminescent device has a structure in which two flat electrodes are simply facing each other. However, in the electroluminescent device according to the present embodiment, the nano structures 130 function, together with the electrode pad 120, as the first electrode 140, and the surface of the first electrode 140 facing the second electrodes 180 extends alongside surfaces of the nano structures 130. Accordingly, in the present invention, the capacitance between the first electrode 140 and the second electrode 180 greatly increases, thereby greatly increasing luminous efficiency which will be described later.

The dielectric layer 150 is deposited on the surface of the first electrode 140. At this point, the dielectric layer 150 is deposited so as to correspond to the shape of the nano structures 130, but does not fill the gaps between the nano structures 130. That is, the dielectric layer 150 is coated on the nano structures 130. The dielectric layer 150 can be deposited by a sputtering method, a chemical vapor deposition (CVD) method, an ALD method, or a sol-gel stacking method.

The dielectric layer 150 may be formed of a material having a high insulation resistance and a high dielectric constant in order to prevent an electric discharge in the dielectric layer 150, and in order to emit light from the light emitting layer 160 with an operating voltage as low as possible. Furthermore, the dielectric layer 150 may have good electron injection characteristics at the interface between the dielectric layer 150 and the light emitting layer 160. The dielectric layer 150 can be formed of an oxide selected from the group consisting of, for example, HfO₄, ZnO, Al₂O₃, SiO₂, MgO, SiNx, TiO₂, and BaO. The dielectric layer 150 can be a mixture of the oxides or can be formed in multiple layers. The present embodiment of the invention can increase the capacitance between the first and second electrodes 140 and 180, respectively, by using the nano structures 130 as electrodes in spite of being limited by the selection of the material for forming the dielectric layer 150. As a result, a large amount of charge is induced at the interface between the dielectric layer 150 and the light emitting layer 160, and thus, electrons can be injected into the light emitting layer 160 from a further increased area of the dielectric layer 150.

The light emitting layer 160 is deposited so as to correspond to the shape of the nano structures 130. At this point, the light emitting layer 160 is deposited so as not to fill the gaps between the nano structures 130. That is, the light emitting layer 160 is coated on the nano structures 130 in the same manner as the dielectric layer 150.

The light emitting layer 160 is formed of an inorganic light emitting material in which an electric field is formed, and emits light by re-stabilizing the inorganic light emitting material which is excited by the electrons accelerated by the electric field applied to the light emitting layer 160. The inorganic light emitting material includes, for example, a metal sulfide such as ZnS, SrS, or CaS, an alkali earth sulfide such as CaGa₂S₄, or SrGa₂S₄, or a transition metal or an alkali rare metal which includes Mn, Ce, Tb, Eu, Tm, Er, Pr, or Pb.

The second electrode 180 covers the light emitting layer 160. The second electrode 180 can be formed of a transparent conductive material, for example, ITO, and can be deposited using a conventional method. At this point, a surface 180a of the second electrode 180 corresponds to the shape of the light emitting layer 160. As a result, the second electrode 180 is separated by a predetermined distance from the first electrode 140 along the surface 180a.

In the present embodiment, a dielectric layer (not shown) can further be formed between the light emitting layer 160 and the second electrode 180. The dielectric layer increases the insulation between the light emitting layer 160 and the second electrode 180, and thus, luminous efficiency can increase. The dielectric layer can be formed of the same material as the dielectric layer 150 which is formed between the first electrode 140 and the light emitting layer 160.

The electroluminescent device according to the present embodiment is a both-side light emitting type in which light is emitted from the light emitting layer 160 through the substrate 110 and the second electrode 180, but the present invention is not limited thereto. That is, the present invention can be applied to a bottom emission type or a top emission type electroluminescent device. Accordingly, the first electrode 140 or the second electrode 180 is not limited to being a transparent electrode, but one of the first and second electrodes 140 and 180, respectively, can be a reflective electrode. For example, the second electrode 180 is a reflective electrode, the second electrode 180 can be formed of a metal having high reflectance such as Ag, and if the first electrode 180 is a reflective electrode, the electrode pad can be formed of Ag.

In the present embodiment, the upper surface of the second electrode 180 is deposited in correspondence to the shape of the light emitting layer 160, but the present invention is not limited thereto.

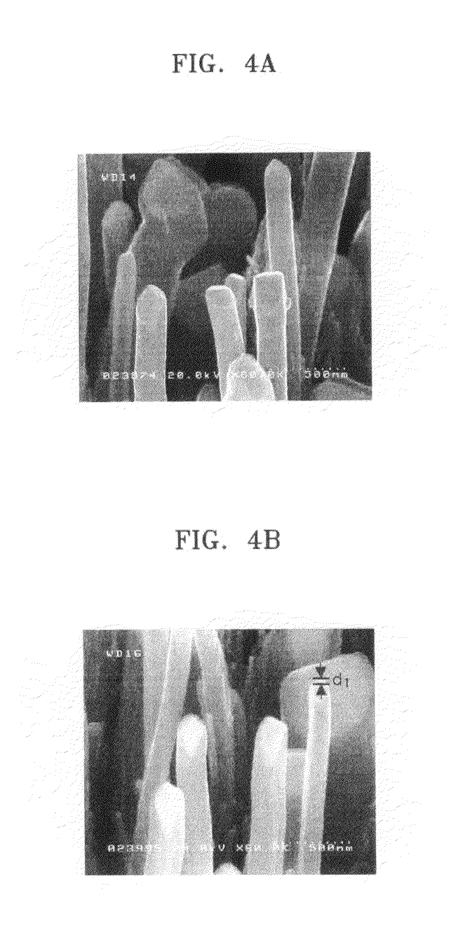

FIG. 3 is a cross-sectional view of a modified version of a second electrode 180′ of the electroluminescent device illustrated in FIG. 2 according to an embodiment of the present invention. The second electrode 180′ is deposited so as to completely fill the gaps between the nano structures 130 which are covered by the dielectric layer 150 and the light emitting layer 160.

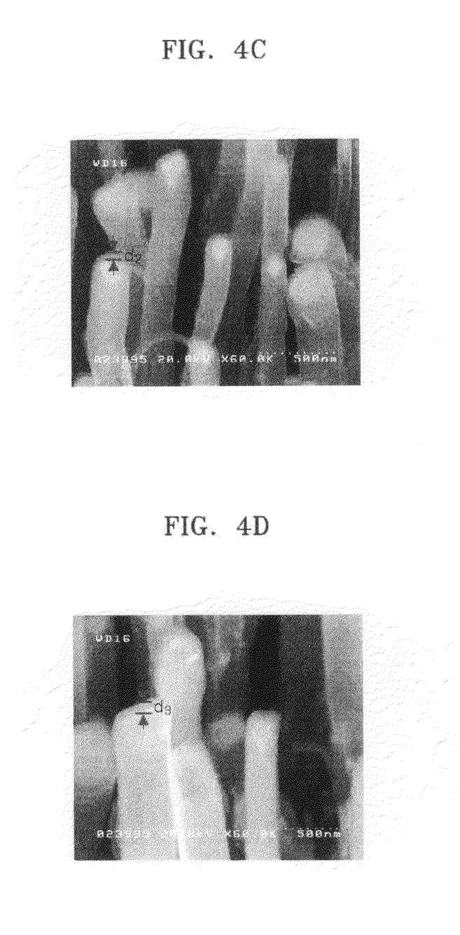

FIGS. 4A thru 4D are scanning electron microscope (SEM) images of a dielectric deposited on carbon nanotubes (CNTs).

FIG. 4A is a scanning electron microscope (SEM) image of CNT structures grown according to an embodiment of the present invention. FIGS. 4B thru 4D are SEM images showing dielectric layers having a different thickness of d1, d2, and d3 deposited on the CNT structures. FIGS. 4B thru 4D illustrate that the dielectric layer 150 and the light emitting layer 160 can be deposited on the nano structures 130 while maintaining the shape of the nano structures 130 as required in the present invention.

Hereinafter, the operation of an electroluminescent device according to an embodiment of the present invention will be described.

Referring to FIG. 2, the electroluminescent device is operated by an external AC current source 190 connected to the first and second electrodes 140 and 180. When a predetermined voltage is applied between the first and second electrodes 140 and 180, respectively, an electric field having a predetermined strength is formed between the first and second electrodes 140 and 180, respectively. Due to the electric field, electrons in the light emitting layer 160 move. The electrons excite a phosphor material in the light emitting layer 160 so as to emit light. The light emitted from the light emitting layer 160 is emitted through the transparent substrate 110 so as to display images or so as to be used as an illuminating light.

The intensity of the light is proportional to the input current. That is, the brightness of the electroluminescent device is proportional to a capacitance occurring when the dielectric layer 150 (which is interposed between the first and second electrodes 140 and 180, respectively) and the light emitting layer 160 are understood to be capacitors.

According to the present invention, since the first electrode 140 includes the nano structures 130, the area where the first electrode 140 and the second electrode 180 face each other is greatly increased, and accordingly, the capacitance of the electroluminescent device greatly increases. This can be defined in Equation 1 which shows a relationship between the area and the capacitance of the conventional parallel flat electric capacitor.

$$C = ɛ \frac{A}{d} \qquad [ Equation 1 ]$$

where e is the dielectric constant of a dielectric, A is an area of an electrode plate of a parallel flat electric capacitor, and d is a gap between the electrodes.

Referring to Equation 1, the capacitance of an electroluminescent device is proportional to an area where the first electrode 140 faces the second electrode 180 of the electroluminescent device.

As the capacitance of the electroluminescent device increases, the current caused by an applied AC voltage increases. This can be defined by Equation 2 which shows a relationship between an operating voltage and the capacitance of the electroluminescent device.

Q=CV [Equation 2]

where C is capacitance, Q is charge on the electrode plates, and V is a voltage applied to the electrode plates. When Equation 2 is differentiated with respect to time and, when an AC voltage is applied between the first and second electrodes 140 and 180, respectively, the charges on the electrode plates with respect to time vary, that is, the current increases. The increase in current according to the increase in capacitance denotes that brightness can increase at the same operating voltage as compared to the conventional electroluminescent device, and also denotes that the electroluminescent device of the present invention can be operated at a lower operating voltage than the conventional electroluminescent device for the same brightness. Therefore, in the electroluminescent device according to the present invention, a low operating voltage can be expected for the same brightness.

Also, since the light emitting layer 160 is formed to correspond to the shape of the nano structures 130, the area of the light emitting layer 160 is relatively large as compared to the area of the substrate 110 where light is emitted. Since the amount of light is proportional to the area of the light emitting layer 160 where light is emitted, the amount of light emitted per unit area of the substrate 110 greatly increases. That is, the light emitting area of the electroluminescent device greatly increases due to the large surface area of the nano structures 130, and thus, the brightness of the electroluminescent device greatly increases at the same operating condition.

In this way, the electroluminescent device according to an embodiment of the present invention can greatly increases brightness and luminous efficiency as compared to the conventional electroluminescent device, and also the operating voltage of the electroluminescent device decreases.

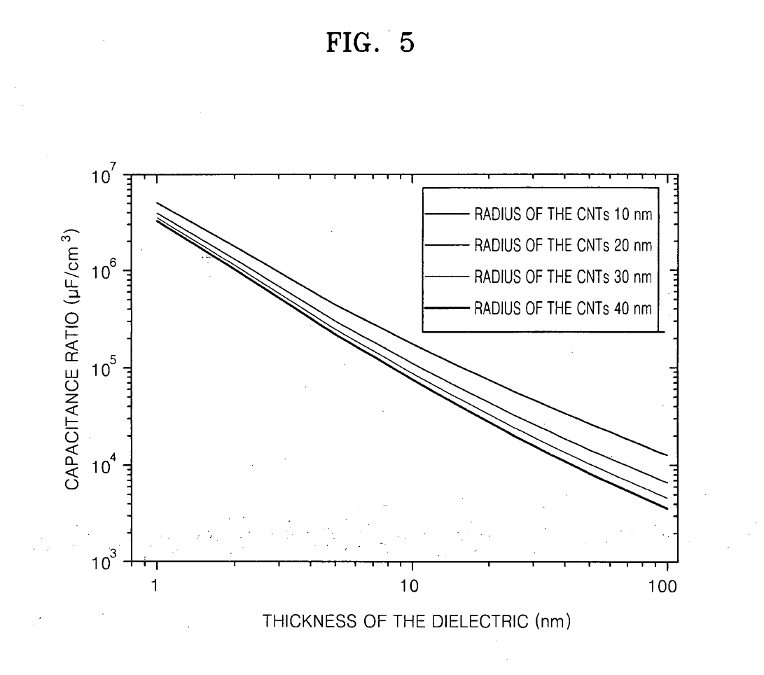

FIG. 5 is a graph showing a capacitance ratio according to the radius of the CNTs and the thickness of a dielectric of an electroluminescent device according to an embodiment of the present invention.

Referring to FIG. 5, as the radius of the CNTs decreases, the capacitance ratio of the electroluminescent device increases. This denotes that the number of CNTs that grow per unit area of the substrate 110 increase as the radius of the CNTs decreases, and accordingly, the total surface area of the CNTs per unit area of the substrate 110 increases. Also, as the thickness of the dielectric layer coated on the surfaces of the CNTs decreases, the capacitance ratio of the electroluminescent device increases due to the fact that the gap between the first and second electrodes decreases.

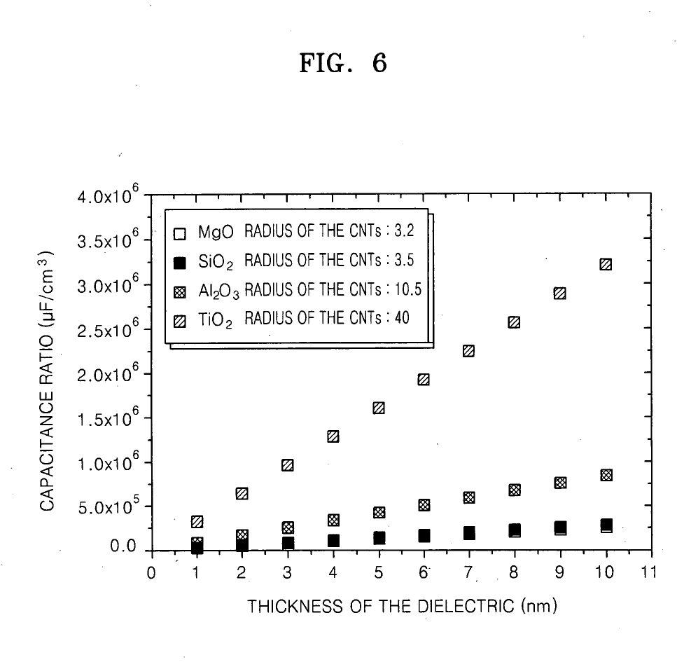

FIG. 6 is a graph showing a capacitance ratio according to the length of CNTs and the kind of dielectric of an electroluminescent device according to an embodiment of the present invention.

Referring to FIG. 6, as the length of CNTs increases, the capacitance ratio of the electroluminescent device increase due to the fact that, as the length of the CNTs increases, the total surface of the CNTs per unit area of the substrate increases. Also, as the dielectric constant of the dielectric layer coated on the surface of the CNTs increases, the capacitance ratio of the electroluminescent device increases.

Table 1 shows the capacitance ratio according to dielectric material.

TABLE 1
unit: nF/cm3

| | MgO | SiO₂ | Al₂O₃ | TiO₂ |
|---|---|---|---|---|
| MWNT(Diameter | 13220.26 | 14456.66 | 43378.97 | 1652.22 |
| ~50 nm) | | | | |
| SWNT(Diameter | 1.86 × 10⁶ | 2.03 × 10⁶ | 6.09 × 10⁶ | 23.20 × 10⁶ |
| ~1.5 nm) | | | | |

Referring to Table 1, in an electroluminescent device, a single walled carbon nanotube (SWNT) having a diameter of approximately 1.5 nm has a higher capacitance ratio than a multi-walled carbon nanotube (MWNT) having a diameter of approximately 50 nm. In particular, a dielectric layer formed of TiO₂ has a capacitance in the order of 1.0×10⁷ nF/cm³.

It is well known that, in the conventional electroluminescent device, in order to perform as an electroluminescent device, the capacitance ratio is required to be more than a few ten thousands nF/cm³ for a typical thick dielectric having a thickness such as 10 μm, and it is required to be more than 400,000 nF/cm³ for a thin film dielectric having a thickness such as 1 μm. However, the electroluminescent device according to an embodiment of the present invention, as shown in Table 1, can have a capacitance ratio greater than 1.0×10⁷ nF/cm³ by appropriately controlling the size of the nano structures and selecting a material for forming the dielectric layer. Therefore, the capacitance ratio of 100 times greater or more than a conventional capacitance ratio can be obtained.

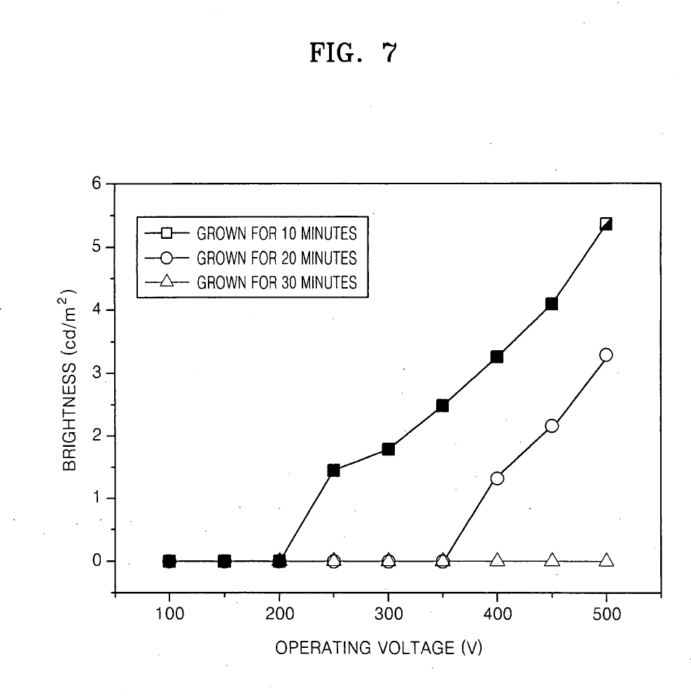

FIG. 7 is a graph showing a relationship between operation voltage and brightness according to growing time of CNTs of an electroluminescent device according to an embodiment of the present invention. Table 2 shows the capacitance of an electroluminescent device according to the growing time of CNTs.

TABLE 2

| | Sample | | |
|---|---|---|---|
| | 10 minutes grown | 20 minutes grown | 40 minutes grown |
| | (4.8 μm) | (8.1 μm) | (31 μm) |
| Capacitance | 800 pF | 1163 pF | 6200 pF |

Referring to Table 2, as the growing time increases, the length of CNTs increases, and also, as illustrated in FIG. 6, the capacitance of the electroluminescent device increases. In this way, as depicted in FIG. 7, by increasing the capacitance of the electroluminescent device by increasing the growing time of the CNTs, a minimum driving voltage for operating the electroluminescent device can decrease, brightness of the electroluminescent device at the same operating voltage as when operating the conventional electroluminescent device can increase, and the operating voltage for the same brightness as when operating the conventional electroluminescent device can decrease.

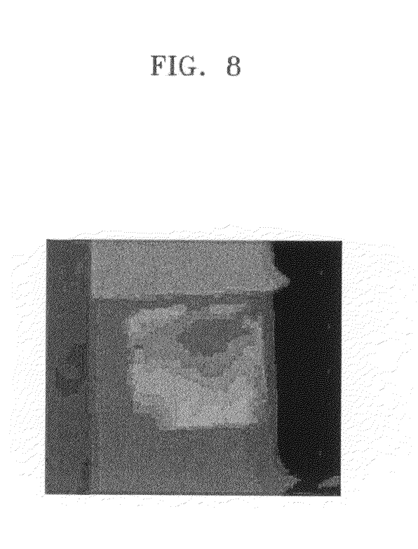

FIG. 8 is a photograph showing light emission of an electroluminescent device having nano structures formed by growing CNTs to a length of 31 μm for 40 minutes according to an embodiment of the present invention.

As described above, the electroluminescent device according to the present invention has increased capacitance due to wide surface area of the nano structures. Therefore, the electroluminescent device has increased brightness at the same operating voltage and a decreased operating voltage for the same brightness.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. An electroluminescent device, comprising:
a substrate;
a first electrode having a plurality of nano structures formed on an upper surface of the substrate;
a dielectric layer formed so as to correspond to a shape of the nano structures;
a light emitting layer formed so as to correspond to a shape of the dielectric layer; and
a second electrode covering the light emitting layer;
wherein a surface of the second electrode facing the light emitting layer is separated by a predetermined distance from a surface of the nano structures.

2. The electroluminescent device of claim 1, wherein the nano structures are one of carbon nanotubes (CNTs), SiC wires, metal wires, and metal oxide nano wires.

3. The electroluminescent device of claim 1, wherein the metal oxide nano wires are one of ZnO and TiO₂.

4. The electroluminescent device of claim 1, wherein the nano structures are perpendicularly grown relative to the substrate.

5. The electroluminescent device of claim 1, wherein the nano structures are grown using one of an atomic layer deposition (ALD) method and a plasma enhanced chemical vapor deposition (PECVD) method.

6. The electroluminescent device of claim 1, wherein the substrate is formed of a transparent material.

7. The electroluminescent device of claim 6, wherein the substrate is one of a glass substrate and a plastic substrate.

8. The electroluminescent device of claim 1, wherein the first electrode further comprises an electrode pad which is formed between the substrate and the nano structures, and which is electrically connected to the first electrode so that a voltage from an external source can be applied to the nano structures.

9. The electroluminescent device of claim 8, wherein the electrode pad is formed of a transparent conductive material.

10. The electroluminescent device of claim 9, wherein the electrode pad is formed of indium tin oxide (ITO).

11. The electroluminescent device of claim 8, wherein the electrode pad and the second electrode are formed in a pattern corresponding to a pixel of a flat display panel.

12. The electroluminescent device of claim 1, wherein the dielectric layer is formed of at least a material selected from the group consisting of HfO₄, ZnO, Al₂O₃, SiO₂, MgO, SiNx, TiO₂, and BaO.

13. The electroluminescent device of claim 12, wherein the dielectric layer is a mixture of different oxides.

14. The electroluminescent device of claim 12, wherein the dielectric layer is deposited using one of a sputtering method, an evaporation method, a CVD method, an ALD method, and a sol-gel method.

15. The electroluminescent device of claim 1, further comprising an additional dielectric layer interposed between the light emitting layer and the second electrode.

16. The electroluminescent device of claim 15, wherein the additional dielectric layer is formed of at least a material selected from the group consisting of HfO₄, ZnO, Al₂O₃, SiO₂, MgO, SiNx, TiO₂, and BaO.

17. The electroluminescent device of claim 1, wherein the second electrode is formed of a transparent material.

18. The electroluminescent device of claim 17, wherein the second electrode is formed of indium tin oxide (ITO).

19. The electroluminescent device of claim 1, wherein one of the first electrode and the second electrode is a reflective electrode.
